(19) United States
(12) Patent Application Publication
(10) Pub. No.: US 2001/0039840 A1
(43) Pub. Date: Nov. 15, 2001

(54) Method of determining fluid inflow rates

(76) Inventor: Lloyd G. Alexander, Calgary (CA)

Correspondence Address: Douglas W. Swartz, SHERIDAN ROSS P.C., Suite 1200, 1560 Broadway, Denver, CO, 80202-5141, US

(21) Appl. No.: 09/811,172

(22) Filed: Mar. 16, 2001

Related U.S. Application Data
(63) Continuation-in-part of application No. 09/267,808, filed on Mar. 12, 1999, now Pat. No. 6,240,787.

(30) Foreign Application Priority Data
Mar. 12, 1998 (CA) 2,231,947

(51) Int. Cl. G01F 1/00

(52) U.S. Cl. 73/861.49

(57) ABSTRACT

Actual inflow rates of gas and liquid into a wellbore from a reservoir are determined by flowing fluid from a wellhead for a prolonged duration so as to affect the reservoir. The flow and the wellhead pressure are measured. Knowing or determining an gas volume, a total rate of fluid inflow from the reservoir can be determined. If the well was previously flowing, then an original fluid flow rate is known. An incremental inflow rate of fluid from the reservoir is calculated as being the difference between the total rate of fluid inflow less the original rate of gas flow. Using an exponential relationship for the pressure change during wellhead flow, a theoretical curve pressure response curve can be created, displayed and compared against the actual pressure response, any deviation therebetween being indicative of fluid inflow from the reservoir.

### CROSS REFERENCE TO RELATED APPLICATION

This application is a continuation-in-part of pending U.S. patent application Ser. No. 09/297,808 filed on Mar. 12, 1999.

### FIELD OF THE INVENTION

A method is provided including introducing a pressure transient into a reservoir for observing and quantifying the reservoir response, specifically, quantifying the inflow of fluid into the wellbore from the reservoir.

### BACKGROUND OF THE INVENTION

In the prior art, it is known to perform draw-down and build-up tests to evaluate the condition of the near wellbore area of a reservoir and the inflow rates of the well. These tests can consume from days to weeks to perform. The pressure is either permitted to fall off or to build up (i.e. the known Horner plot). The pressure response is analyzed at the tail end of the test, as it approaches steady state.

In the drill-stem test, still used regularly in the industry today, gas is vented from the wellhead through an orifice and the flow rate is measured. The measured flow rate out of the wellhead is presumed to be directly attributable to the flow into the well from the reservoir. Unfortunately, one cannot know the inflow rate based on the outflow alone. If a larger orifice is chosen, the observed rate will be misleadingly higher. If the orifice is smaller, the observed rate can be misleadingly and pessimistically lower. These results are dependent not upon the reservoir performance but instead on the throughput of the orifice at the observed surface pressure. In the most obvious case of mis-information, if the observed pressure is changing while venting then the measured outflow cannot equal the inflow. Even more difficult to assess is for the case of gas-free liquid entering the well where substantially only liquid-displaced gas will be measured as outflow.

There is a demonstrated need for a fast and simple method of determining well inflow rates.

In related prior art, known as closed-chamber testing, particular characteristics of a well can be determined without prolonged discharge from the well, as disclosed in U.S. Pat. No. 4,123,937 issued to the applicant. This reference discloses a method of determining annular gas rates and gas volume in the well annulus by measuring the change in pressure during blocked flow and briefly flowing a measured amount of gas from the well. Depending upon and assuming a linear rate of change of pressure, gas flow is calculated as a function of the ratio of the gas flow to the rate of pressure change using mass balance techniques. This prior art method of alternately blocking and permitting annular flow is applied to pumping wells as a means for determining the annulus gas rate without causing a significant change in the bottom hole pressure (usually less than about 10 kPa). With little change in the bottom-hole pressure, the reservoir response is not affected.

In U.S. Pat. No. 4,123,937, the pressure during the flow of gas from the well's annulus is observed. This rate of pressure decline during gas flow is assumed to be linear. Due to the short test duration and lack of reservoir involvement, the approximation is usually sufficient.

As described in the prior art, for any gas-filled space, a general equation for the behavior of gases, which will be familiar to those skilled in the art, can be derived, which has many applications within the oil and gas industry, one of which is the subject of the method according to the present invention.

Generally, nomenclature used is as follows:

M=molecular weight of gas

W=mass of the gas (kg)

P=pressure (kPa abs.)

Q₁ or Qᵢₙ=gas flowrate into a system (m³/d)

Q₂ or Qₒᵤₜ=gas flowrate out of a system (m³/d)

T=temperature (deg. K)

V=gas volume of system, before testing (m³)

n=the number of moles

R=the universal gas constant

z=gas deviation factor

dP/dt=rate of change of pressure (kPa/min)

dV/dt=rate of change of volume (m³/min)

F=Prover (orifice) plate coefficient.

G=Gas gravity

Subscript sc=standard conditions

Simply, PV=nRTz and by replacing the number of moles n, with the weight of the gas divided by the molecular weight of the gas, the equation can then be rewritten as PV=nRTz or

$$W = \frac{PVM}{RTz}$$

where W is the mass of the gas in the system in kilograms.

Similarly, the density of the gas in kg/m³ can be written as

$$\frac{W}{V} = \frac{PM}{RTz} .$$

The mass rate in or out is equivalent to the flow rate of gas in standard m³/min multiplied by the density in kg/m³. Mathematically, this mass rate is expressed as

$${Mass}_{in} = {Q}_{1} \frac{{P}_{sc} M}{{RT}_{sc}}$$

and similarly

$${Mass}_{out} = {Q}_{2} \frac{{P}_{sc} M}{{RT}_{sc}}$$

where Q₁ and Q₂ are defined as the gas flowrate in and out of the wellbore respectively.

In order to have a mass balance the rate of change of mass in the system must be equal to the difference between the mass rate in and the mass rate out. Mathematically, this rate of change is expressed as the change in mass in the system over time=mass rate in−mass rate out, or

$$\frac{ⅆ ( \frac{{P}_{sc} M}{{RT}_{sc}} )}{ⅆ t} = Q \frac{{P}_{sc} M}{{RT}_{sc}} - {Q}_{2} \frac{{P}_{sc} M}{{RT}_{sc}} .$$

If we assume that T and z are constant, then this equation can then be differentiated as follows

$$\begin{matrix}M \frac{( V \frac{ⅆ P}{ⅆ t} + P \frac{ⅆ V}{ⅆ t} )}{RTz} = M \frac{{P}_{sc} ( {Q}_{1} - {Q}_{2} )}{{RT}_{sc}} or \\ {Q}_{1} - {Q}_{2} = {T}_{sc} \frac{( V \frac{ⅆ P}{ⅆ t} + P \frac{ⅆ V}{ⅆ t} )}{{TzP}_{sc}}\end{matrix}$$

The units on both sides of the equation are in m³/min. If we express Q₁ and Q₂ in m³/day then the left side of the equation must be divided by 1440 minutes per day. If T_{sc}=275.15+15 degrees Kelvin and P_{sc}=101.325 kPa, then the equation can be expressed as:

$$\begin{matrix}{Q}_{1} - {Q}_{2} = 4095 \frac{( V \frac{ⅆ P}{ⅆ t} + P \frac{ⅆ V}{ⅆ t} )}{Tz} or K = \frac{4095}{Tz} \\ {Q}_{1} - {Q}_{2} = KV \frac{ⅆ P}{ⅆ t} + KP \frac{ⅆ V}{ⅆ t}\end{matrix} \qquad ( 1 )$$

The above equation (1) therefore can be considered to be the fundamental equation that satisfies the mass balance of a system and can be used as a steppingstone in evaluating oil and gas wells, flowing or pumping. The derivation of this fundamental equation has been previously disclosed in U.S. Pat. No. 4,123,937 and can be used as the starting point in the development of additional processes to support the new method of testing.

### SUMMARY OF THE INVENTION

Simply, a method is provided for determining the actual inflow rates of fluids into a wellbore from a reservoir. Moreover, this determination is performed while flowing wellbore fluid from the wellhead for a duration sufficient to affect the reservoir and thereby provide representative results.

In one broad aspect of the invention, a method is provided for determining the inflow of fluid from a reservoir into the wellbore of a well completed into the reservoir. The method broadly comprises the steps of:

flowing gas out of the wellhead for a prolonged duration sufficient to affect the reservoir;

measuring the wellhead gas outflow rate;

measuring the pressure of the flowing gas at the wellhead over time; and

determining the total rate of fluid inflow from the reservoir as a function of the wellhead gas outflow rate, a change in flowing gas pressure, and a volume of gas in the wellbore.

The volume of gas may be established through conventional methods including having prior knowledge of the geometry of the well or through a method of the invention by performing a closed chamber test in advance of flowing gas from the wellhead.

If the inflow is only gas, then the gas volume remains constant while the gas flows out of the wellhead. Prior to the

In cases where a flowing well is temporarily closed in a method for determining the volume, there is usually still a fluid inflow rate, comprising a diminishing inflow rate as the well pressure builds up. When the well is again flowed according to the present invention, then the inflow rate is the inflow rate during build up and an incremental fluid inflow rate.

If the fluid inflow is known to be liquid, then the change in gas volume in the wellbore is not constant—that magnitude of the change to the inflow rate being the liquid inflow. The incremental change in volume being determined knowing the gas volume and gas inflow rate, the wellhead flow rate, the instantaneous pressure and the actual incremental change in pressure.

In another preferred application of the method of the invention, a theoretical curve of the system's pressure response can be created and compared against the actual pressure response, any deviation therebetween being indicative of fluid inflow from the reservoir. Further, the theoretical curve can be created for permitting a wellsite operator to make certain decisions about testing procedures such as what size prover orifice to use to ensure a sufficient draw-dwon pressure is achieved over a sufficiently long test period.

### BRIEF DESCRIPTION OF THE DRAWINGS

FIG. 1 is a cross-sectional representation of a conventional crude oil or gas well and associated surface equipment or wellhead;

FIG. 2 is schematic representation of the wellbore at various steps of the preferred embodiment of the invention and the associated pressure response;

FIG. 3 illustrates steps A and B of the method and identifies the selection of the first and second pairs of pressure values;

FIG. 4 depicts a schematic of test apparatus used in illustrative Example I;

FIG. 5 is a graph illustrating the change in pressure in the test apparatus of FIG. 4 and the calculated fluid inflow rates if the fluid is all gas;

FIG. 6 is a graph illustrating the change in pressure in the test apparatus of FIG. 4 and the calculated fluid inflow rates if the fluid is all liquid;

FIG. 7 is a graph illustrating the change in pressure in a pumping oil well of illustrative Example II and the calculated liquid inflow rates;

FIG. 8 is a graph illustrating application of about a 60 minute duration of the step C embodiment of the present invention to a shut in gas well of illustrative Example III, with the theoretical and calculated gas inflow rates; and

FIG. 9 is a Horner Plot over about a 2 week duration according to the illustrative Example III.

### DETAILED DESCRIPTION OF THE PREFERRED EMBODIMENT

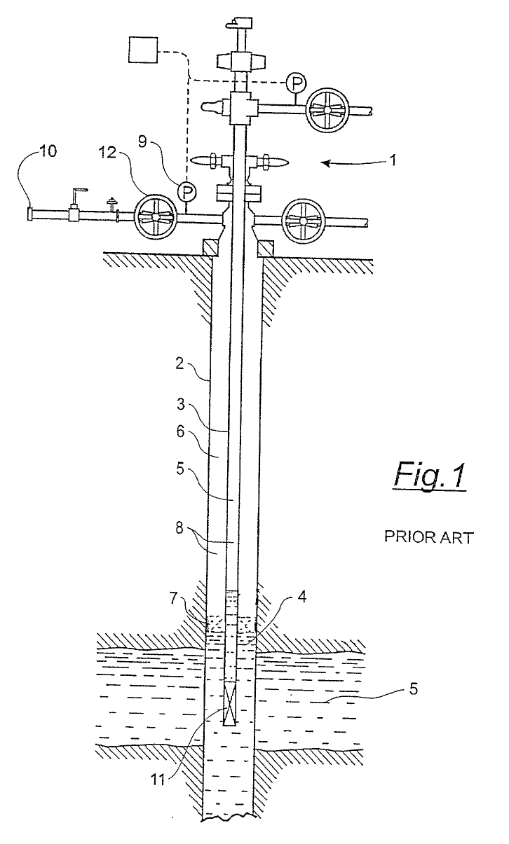

Having reference to FIG. 1, a conventional well is shown comprising a wellhead 1, well casing 2, and a tubing string 3 extending downwardly inside the bore of the casing 2. The casing 2 is perforated adjacent its bottom end 4 for permitting reservoir fluid 5 to flow into the system typically formed of the annulus 6 formed between the casing 2 and the tubing string 3. A packing 7 may or may not be fitted into the annulus 6 and thus the flow of fluid can be up the bore of the tubing string 3, the annulus 6 or both 3,6. Generally then, the system or volume in which fluids may travel up the well to the surface is deemed to form the wellbore 8, usually comprising the annular space 6 and tubing string 3.

A pressure transducer 9 monitors and records the pressure in the wellbore 8. A pump 11 is often fitted to the bottom of the tubing string 3.

As disclosed in U.S. Pat. No. 4,123,937, the method of calculating wellbore gas volume V and flow rate (Q₁) comprises measuring the change in wellbore pressure over time for two sets of flow conditions; one set while temporarily blocking flow from annulus, and a second set while briefly flowing and measuring the flow rate of gas from the wellbore. Means for measuring gas rates include a flow measurement device such as a critical flow prover 10 to a port on the wellhead 1. The prover 10 comprises a vent plate having a vent orifice of predetermined calibrated size mounted to a valve port 12 used to selectively open and close the gas path between the wellhead and the prover 10.

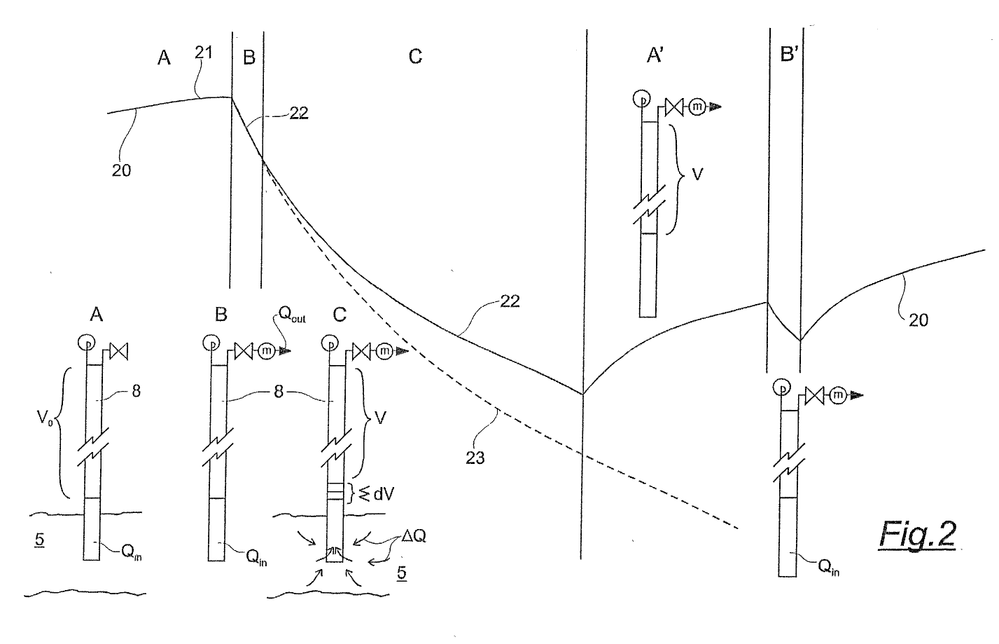

Having reference to FIG. 2, a schematic representation of the new method is illustrated. Various schematic states of the wellbore are displayed as they correspond to the dP/dt pressure response 20.

In a first embodiment, steps A, B and C are performed to establish measures of the rate of fluid flow in the wellbore 8. Typically, upon drawdown, this would be the fluid inflow from the reservoir 5 into the wellbore 8 (see FIG. 1).

The method of the present invention is one in which a transient response to the reservoir is introduced, but is achieved without the protracted build-up durations required in the prior art Horner plot methodology.

To introduce a transient, a drawdown of reservoir pressure is introduced. For a shut in gas well, this can be accomplished simply by opening the well and flowing gas. For a steady state flowing gas well, the inflow rate is already known. For a producing oil well, one suitable scenario is to shut in the liquid oil flow and blowdown the well by flowing gas head existing or introduced), such as from the annulus for affecting the reservoir pressure.

### Determination of Fluid Flow Rate—Step A

More specifically, if a well is already flowing, and one wishes to ascertain the original magnitude of the gas volume, then step A is performed wherein the operator blocks flow at the wellhead 1 and measures the surface pressure 9 and its rate of change. The pressure response 21 is linear. The change in pressure indicates that something is entering or leaving the wellbore (Qᵢₙ). This is an original gas flow and is available if the wellbore has been disrupted for performing step A. If the wellhead has already been shut in for a prolonged time, and the reservoir is at steady state then Qᵢₙ is zero.

Assuming any Qᵢₙ is only due to gas flow, then the volume of gas in the wellbore V₀ must remain constant and thus

$$\frac{ⅆ V}{ⅆ t} = 0.$$

While the prover is closed 10, Qₒᵤₜ is zero and fundamental equation (1) derived above becomes:

$${Q}_{in} = KV \frac{ⅆ P}{ⅆ {t}_{closed}} \qquad ( 2 )$$

where

$$\frac{ⅆ P}{ⅆ {t}_{closed}}$$

is the change in pressure evaluated when the prover is closed and both V and Qᵢₙ remain unknown.

Step B

Then for step B, the pressure response 22 is changed. This is typically performed by venting gas in the wellbore 8 through the critical flow prover 10. The prover 10 has a known plate size and the pressure differential across the wellhead 1 for the wellbore 8 must be sufficient to achieve critical flow through the prover. Alternatively, if the pressure in the well is too low, nitrogen is progressively injected through the prover 10 to increase the pressure.

Unlike the prior art closed chamber test, where the short duration of the drawdown results in a substantially linear pressure response, an embodiment of the invention as applied at step C extends the duration of the test. Initially however, and throughout the short duration of B, pressure at the wellhead 1 changes but the pressure change is not immediately apparent at the reservoir 5. Flow of fluid at the reservoir 5 is not affected. Thus, it can be assumed that the original gas flow rate Qᵢₙ at A is the same for Qᵢₙ at B and V₀ does not change. The net fluid inflow is then described as:

$${Q}_{in} - {Q}_{out} = {KV}_{o} \frac{ⅆ P}{ⅆ {t}_{open}} \qquad ( 3 )$$

where Qₒᵤₜ is measured,

$$\frac{ⅆ P}{ⅆ {t}_{open}}$$

is the change in pressure evaluated when the prover is open and both V₀ and Qᵢₙ remain unknown.

During the short duration of step B, the prior art has assumed that the response 22 has been linear.

More exactly and as disclosed in the present invention, the pressure response 22 throughout steps B and C is an exponential one. The pressure response 22 can be defined as follows.

Using the prover 10 as the measurement device m, then

$${Q}_{out} = PF \sqrt{\frac{{T}_{sc}}{GTz}}$$

where F is the prover flow coefficient. The prover characteristic as a function of pressure can be defined as C so that Qₒᵤₜ=PC. Again, assuming

$$\frac{ⅆ V}{ⅆ t} = 0$$

and substituting Qₒᵤₜ into equation (4) and rearranging yields:

$${Q}_{in} = PC + KV \frac{ⅆ P}{ⅆ {t}_{open}} \qquad ( 4 )$$

Rearranging equation (4) yields the exponential form of the equation as

$$ⅆ {t}_{open} = \frac{{KVdP}_{open}}{{Q}_{in} - PC} .$$

Integrating both sides with respect to time, between t₁ and t₂, yielding

$$C ( {t}_{2} - {t}_{1} ) = - KV ln ( \frac{{CP}_{2} - {Q}_{in}}{{CP}_{1} - {Q}_{in}} ) \qquad ( 5 )$$

Qₒᵤₜ is measured, where both V and Qᵢₙ are also unknown.

Simply, now two equations (2) and (5) are known, enabling the solution for the two unknowns, gas volume V and Qᵢₙ.

Inserting equation (2)

$${Q}_{in} = KV \frac{ⅆ P}{ⅆ {t}_{closed}}$$

into the equation (5) yields:

$$C ( {t}_{2} - {t}_{1} ) = - KV ln ( \frac{{CP}_{2} - KV \frac{ⅆ P}{ⅆ {t}_{closed}}}{{CP}_{1} - KV \frac{ⅆ P}{ⅆ {t}_{closed}}} ) \qquad ( 6 )$$

Equation (6) becomes the working equation for the new method wherein all variables can be solved numerically except for volume V.

### Calculation of Initial Gas Volume V₀—Steps A and B

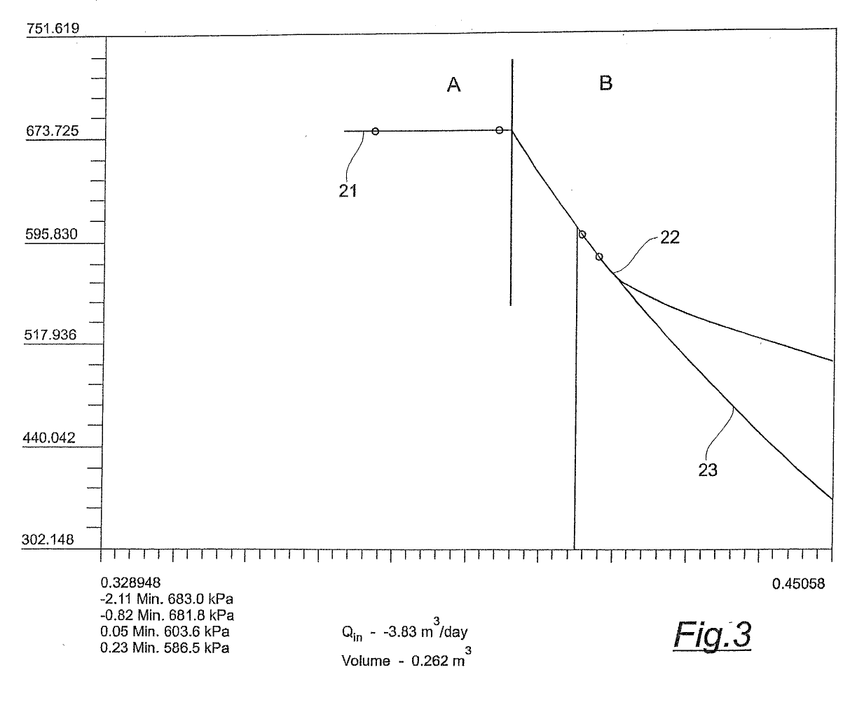

Referring to FIGS. 2 and 3, in solving equation (6) for volume V₀, four points are selected for pressure P at time t. In step A, the first two points are taken during a linear portion of the curve 21, prior to opening the prover 10. This pressure response 21 is defined by equation (2) in which both V and Qᵢₙ are unknowns.

In step B, the second two P₁, t₁ and P₂, t₂ points are taken from response 22 as soon as possible (within seconds) of the prover 10 being opened. The points are selected where the reservoir 5 is not yet involved (the duration is insufficient to affect the reservoir.

Equation (6) cannot be solved directly, but can be solved using numerical iteration, most preferably using an iterative computer program. Using one of many various numerical methods techniques, known to those of ordinary skill in the art, equation (6) can easily be solved for any one of the variables knowing the other variables.

Equation (6) is solved in an iterative process and the value of V₀ is calculated. Knowing V₀, equation (2) can be solved to obtain the original inflow rate Qᵢₙ.

### Theoretical Pressure Response—Visual Indication of Fluid Inflow

In another embodiment, it can be useful for an operator to obtain a qualitative on-site visual indication on the display of a portable computer of the performance or fluid inflow rate of the well. A theoretical pressure response 23 can be illustrated and plotted against the actual pressure response 22. If the actual and theoretical responses 22,23 match then the operator is able to state that there is no additional or incremental fluid inflow ΔQ. If the two responses 22,23 deviate, then there must be an incremental fluid inflow ΔQ.

For determining the theoretical response 23, the known values of V₀ and Qᵢₙ can be inserted into equation (6) for calculating a theoretical pressure response over time

$${[ \frac{ⅆ P}{ⅆ t} ]}_{Theo}$$

for a system having constant volume V and constant gas inflow Qᵢₙ, vented through a known prover plate 10.

More particularly, from inspection one can see that equation (6) has the general form of

$$ln ( \frac{a}{b} ) = d .$$

Rearranging, one can write a=be^{d}, where, applied to equation 6, a=CP₂−Qᵢₙ, b=CP₁−Qᵢₙ, and

$$d = - \frac{C ( {t}_{2} - {t}_{1} )}{KV} .$$

Accordingly, Equation (6) can be rewritten as

$${CP}_{2} - {Q}_{in} = ( {CP}_{1} - {Q}_{in} ) {ⅇ}^{\frac{c ( {t}_{2} - {t}_{1} )}{KV}} or \\ {P}_{2} = ( {CP}_{1} - {Q}_{in} ) {ⅇ}^{\frac{- c ( {t}_{2} - {t}_{1} )}{KV}} + \frac{{Q}_{in}}{C} \qquad ( 7 )$$

Equation (7) enables calculation of the surface pressure response

$${[ \frac{ⅆ P}{ⅆ t} ]}_{Theo}$$

for the theoretical case.

Whether a theoretical response is determined or not, knowing V₀ and Qᵢₙ, the actual response of the reservoir fluid inflow rates can be determined from the actual pressure response in step C when the prover is open

$$\frac{ⅆ P}{ⅆ {t}_{open}} or \frac{ⅆ P}{ⅆ {t}_{actual}} .$$

Step C

As stated, for the first embodiment, the well test is extended into step C, the objective being to markedly change the pressure response 22 so as to affect the reservoir 5 and accentuate changes in fluid flow into or out of the wellbore 8. These changes in the fluid flow, coupled with the pressure drawdown over time provide the background to quickly ascertain and calculate, in a conventional manner, reservoir transmissibility and a skin factor.

Thus, in contradistinction to the minimum pressure drop used in the prior art closed chamber test, the duration of the venting period applied in the present invention is prolonged so as to intentionally disturb the reservoir 5. Where the known closed chamber test may typically experience a small 10 kPa pressure change, the deliberately introduced pressure change of the present invention is usually in the order of 80 to 1000 kPa or more. The “prolonged” duration or time required to impart this transient into the reservoir 5 can vary from minutes (for a well with high flow rates) to hours (low flow rates). This is still a vast shange from the prior art buildup tests which can take weeks.

In the case where Qₒᵤₜ is being released from the wellbore 8 and surface pressure 9 is reducing, the reservoir 5 typically responds with an increased production of fluid (not considering anomalous wellbore phenomenon such as foam formation or collapse). The fluid inflow Qᵢₙ from the reservoir could be liquid, gas or a combination thereof. Over time, in response to the increased inflow, the rate of pressure decrease slows, having an exponential response. Eventually, the rate of pressure change will flatten to a steady state value (not shown). The prior art drawdown test seeks to achieve this steady state value. The method of the present invention does not require the pressure change 22 to achieve steady state.

For the first time, the actual dP/dt response 22 of a conventional well test procedure is converted into values of fluid inflow rates representative of the reservoir's capability.

If the reservoir fluid flow rate is unchanged between steps A and C then equation (2) should balance, V₀ and Qᵢₙ being constant. If equation (2) doesn't balance, the actual and theoretical responses 22,23 will deviate which is easily ascertained by inspection.

Now, while measuring flow Qₒᵤₜ at the wellhead 1, the actual pressure response 22 permits determination of a reservoir-wellbore fluid flow rate which is different than determined in step A and B.

### Incremental Reservoir Fluid Flow ΔQ

When calculating actual total fluid inflow using

$${Q}_{tot} = KV \frac{ⅆ P}{ⅆ {t}_{actual}}$$

and if Qₜₒₜ is not equal to Qᵢₙ, then there must be an incremental fluid flow ΔQ as defined by:

$${Q}_{tot} = Δ Q + {Q}_{in} = {Q}_{out} + {{KV}_{o} [ \frac{ⅆ P}{ⅆ t} ]}_{Actual} OR \\ Δ Q = {Q}_{out} + {{KV}_{o} [ \frac{ⅆ P}{ⅆ t} ]}_{Actual} - {Q}_{in} \qquad ( 8 )$$

Taken alone, equation (8) defines the incremental flow rate ΔQ of fluid.

Basically, three cases arise: ΔQ is all gas, ΔQ is all liquid, ΔQ is gas and liquid.

In the first case, if it is known that the phase of the fluid is all gas then V remains constant and equation (8) can be used directly to calculate the incremental gas inflow rate ΔQ. The overall or total gas inflow rate Qₜₒₜ from the reservoir would be Qᵢₙ+ΔQ.

Alternately, in the second and third cases, the inflow ΔQ may include liquid and thus the gas volume V₀ may be changing an incremental amount

$${\sum }_{t1}^{t2} ⅆ V .$$

If

$$\frac{ⅆ V}{ⅆ t}$$

is negative, volume V₀ is getting smaller and thus liquid must be entering the system. The magnitude of the liquid flow is the absolute value of the negative gas flow.

For the third case, where all the fluid flow is all liquid, then the gas volume will change. More particularly, the gas volume will exactly change by the volume of liquid inflow. If one continues to assume that Qᵢₙ is a constant, and that

$$\frac{ⅆ V}{ⅆ t} \neq 0 , then {Q}_{in} - {Q}_{out} = K ( {V}_{new} ) \frac{ⅆ P}{ⅆ t} + KP \frac{ⅆ V}{ⅆ t}$$

where V_{new}=V₀+ΣdV. For each increment in time,

$$dV = \frac{ⅆ V}{ⅆ t} dt$$

and when added to the original volume V₀ then rearranging gives:

$$\frac{ⅆ V}{ⅆ {t}_{liq}} = - \frac{ⅆ V}{ⅆ {t}_{gas}} = - ( \frac{{Q}_{in}}{K \overline{P}} - \frac{{Q}_{out}}{K \overline{P}} - \frac{( {V}_{o} + \sum ⅆ V )}{P} \frac{ⅆ P}{ⅆ t} ) \qquad ( 9 )$$

where P is the instantaneous pressure in the wellbore at surface 9 and \overline{P} is the average pressure over dt. In the first instance of an iterative calculation, V_{new}=V₀ and every variable is known except

$$\frac{ⅆ V}{ⅆ t} .$$

For each dt slice in time,

$$\frac{ⅆ V}{ⅆ t}$$

can be calculated, dV is calculated, and V_{new} is increased by another increment of dV.

Iteratively, a new incremental volume change

$${\sum }_{t1}^{t2} dV$$

can be determined where

$${V}_{new} = {V}_{o} + {\sum }_{t1}^{t2} dV$$

throughout step C.

The gas and liquid-only cases bound the second case wherein the fluid flow comprises both gas and liquid.

### Determining Gas And Liquid Phase Fractions

In the second case, where it is unknown whether the fluid is gas, liquid or a mixture of both, more testing is required.

If the volume V in the wellbore can be determined after step C, then the difference between the volume V₀ at A and the volume V at the conclusion of step C will be illustrative of the volumetric fraction V_{liq} of the ΔQ inflow which was liquid. The decrease in gas volume is V_{f}=V₀−V and the incremental inflow of liquid is

$${Q}_{liq} = \frac{{V}_{o} - V}{t} .$$

Thus, of the incremental inflow ΔQ, and amount Q_{liq} would be liquid and the inflow rate of gas is Q_{gas}=ΔQ−Q_{liq}.

To establish whether the volume of gas V has changed, one of several techniques could be used. After step C, a sonic fluid level could be determined to establish V. This method is unfortunately inaccurate in situations involving foam. Alternately, a bottom hole pressure sensor can employ measures of hydrostatic head to calculate changes in liquid depth and thus gas volume. It is not always feasible to employ bottom hole sensors, such as in pumping wells.

Accordingly, in an extension of the test disclosed above, a repeat of the A and B steps of the test can be performed as steps A′ and B′.

Steps A′ and B′

In a third embodiment, and as shown in FIG. 2, two additional steps A′ and B′ can be performed to determine the quality of the fluid as being gas, liquid or a mixture. Similar steps are taken as was described for steps A and B above, more particularly, the prover is closed for step A′ and the first two points of the pressure response 22 are selected. Then the prover 10 is opened for step B′ and the second two points are selected. Equations (2) and (6) are again solved for the new value of V and Qᵢₙ. The volume V at A′ is compared to the volume V₀ calculated at A. The incremental liquid inflow ΔQ is then calculated as stated above.

### EXAMPLE I

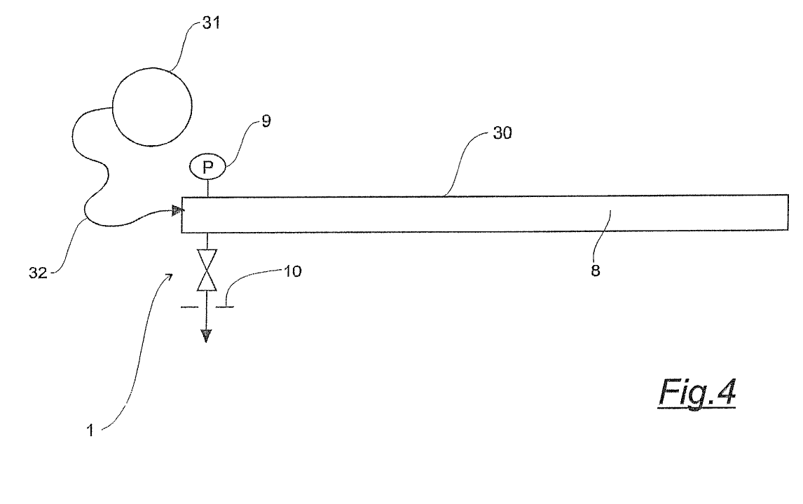

As shown in FIG. 4, a 149 m long piece of plastic tubing 30 having an internal diameter of 48.4 mm was used to simulate a wellbore 8. The actual volume V₀ of the tubing 30 was 0.274 m³. An air compressor 31 was connected by small bore flexible hose 32 to the tubing's bore to simulate ΔQ gas flow into the wellbore 8. In this particular instance, the tubing 30 had a leak and thus there was a simulated gas outflow Qᵢₙ of −3.82 m³/day. As a flow measurement device, the tubing 30 was fitted with a critical flow prover 10. A recording pressure transducer 9 was also located adjacent the end of the tubing 30 having the prover 10, representing the wellhead 1.

Compressed air was forced into the tubing 30 to simulate about 200 m³/day of incremental gas inflow ΔQ.

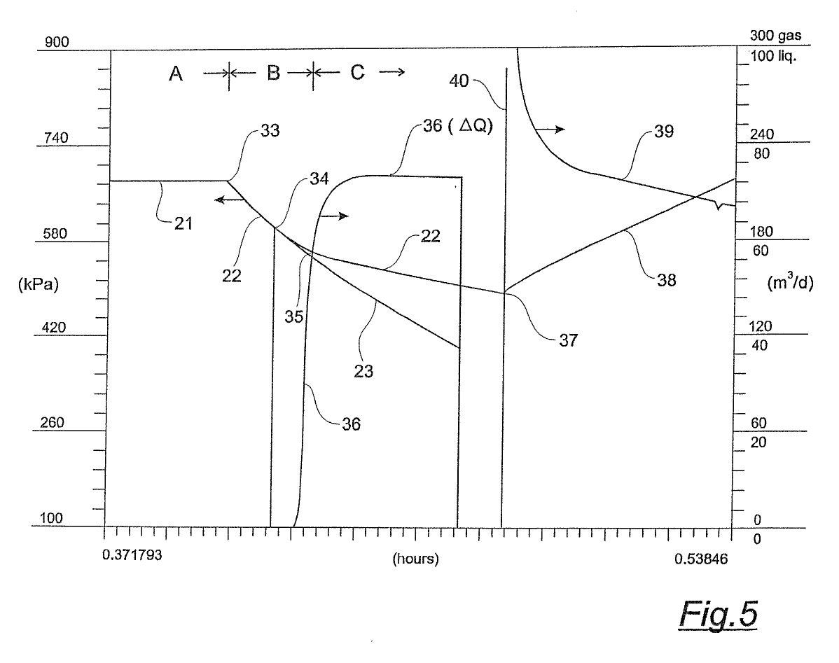

As shown in FIG. 5, initially the tubing 30 was pressurized to about 680 kPa as step A. For steps B and C, the critical flow prover 10 was opened. The prover 10 had a plate factor of 0.59388. Temperature was deemed 273.15.

The prover 10 was opened at 33. Due to physical constraints, it was only at 34 that the recording instruments were activated to record the actual pressure response 22 representative of step B and the start of step C.

As was shown in FIG. 3, four points were selected. Note that according to equations (2) and (6), sufficient information then existed to calculate and draw the theoretical exponential pressure response 23 as if the leak (simulating Qᵢₙ), was the only flow from the tubing throughout step C.

At 35 the compressor was switched on, simulating incremental fluid flow ΔQ and causing the actual pressure response 22 to deviate from the theoretical curve 23.

Using equation (8), assuming the incremental flow ΔQ is only gas, as it was in the simulated example, then the incremental gas rate ΔQ was calculated and is displayed as curve 36.

Step C was terminated at 37 by closing the prover 10. With the compressor still switched on, the surface pressure 9 again climbed shown as 38. With the prover 10 closed, Qₒᵤₜ=0, and the simpler closed-chamber testing of the prior art was applied to ascertain the value of V and the fluid flow 39 or Qᵢₙ. Note the close correspondence of the rates 36, 39 calculated by the new method and prior art method respectively. The new method was calculated with flow Qₒᵤₜ at the wellhead, and prior art method was calculated with the wellhead blocked. In contradistinction with the prior art, the new method permits calculation of fluid flow rates for a well in which there is significant flow at the wellhead 1, involving the reservoir 5.

Note that a spike 40 appeared in the gas rate calculation. This spike 40 is believed to be an artifact due to the equalization of pressure which took place between the relatively large (0.06 m³) tank of the compressor 31, through 10 meters of small diameter air-line hose 32, and to the tubing 30, when the prover 10 was closed.

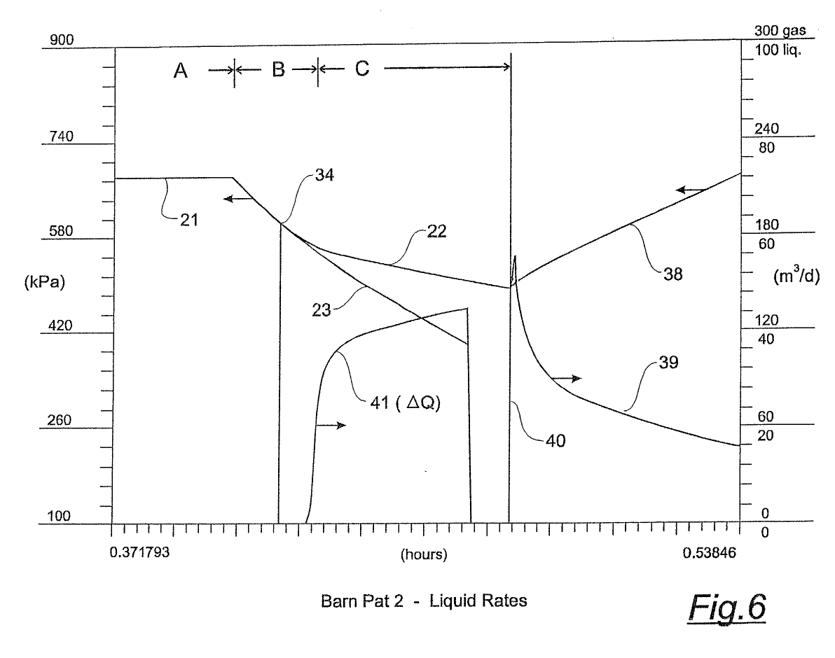

In FIG. 6, the same test is illustrated, yet the liquid-only equation (9) was used on the pressure response data instead of equation (8), thereby illustrating the calculated liquid rate as if the fluid being introduced to the tubing 30 was liquid rather than compressed air.

### EXAMPLE II

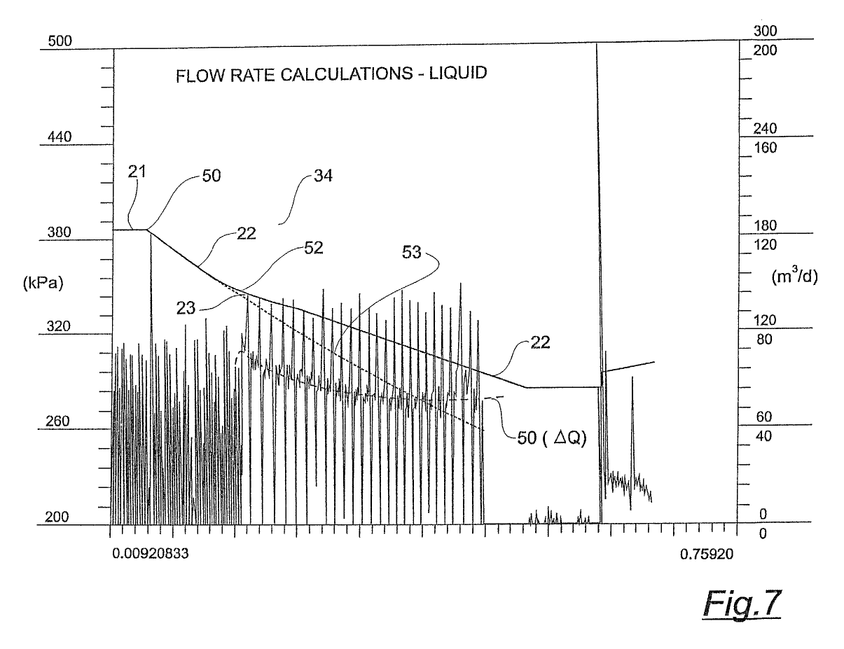

As shown in FIG. 7, the new method was applied to a known, pumping oil well having a low gas-oil-ratio (GOR). The actual pressure response 22 was very sensitive and should have been electronically filtered but was not. As shown, curve 50 representing fluid flow calculations, which were based upon the pressure response 22, accentuated the pressure swings however the fluid flow rate was distinguishable.

The well had a surface pressure at the wellhead of about 305 kPa. A prover was fitted to the wellhead and was opened at 51. The recording of pressure the response 22 was also obtained immediately.

V and Qᵢₙ were determined.

For illustrative purposes, a theoretical pressure response is presented as 53.

Equation (9) was applied to the pressure response 22 of this known liquid-only producing well. Incremental liquid inflow rates ΔQ were calculated at about 68.7 m³/day.

Actual average liquid production was measured in the on-site tankage in two instances at about 70.1 and 71.1 m³/day.

### EXAMPLE III

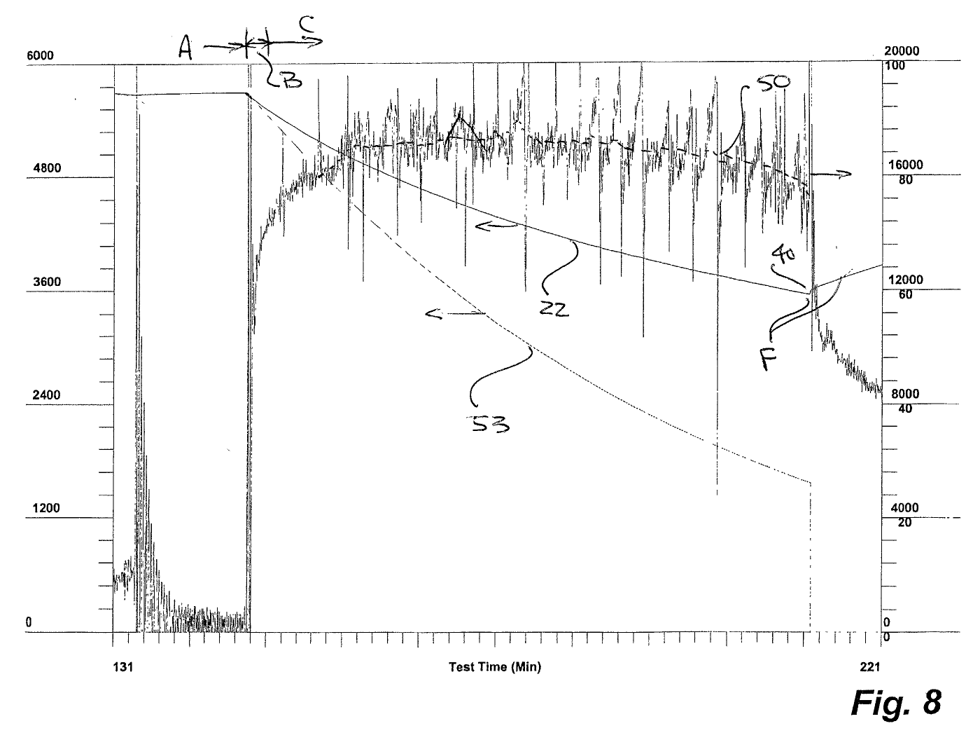

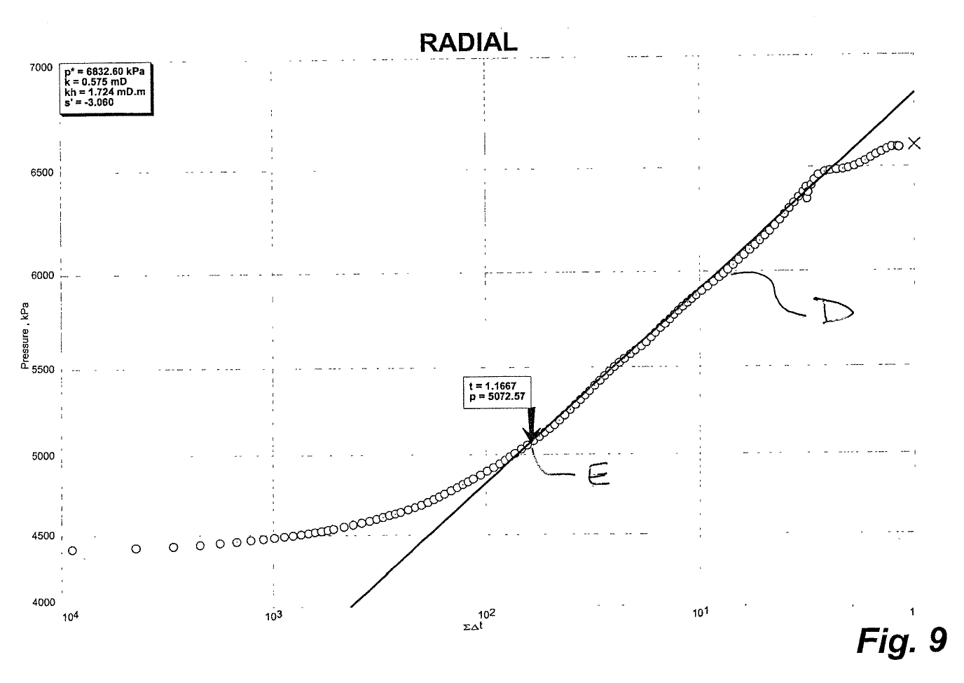

As shown in FIGS. 8 and 9, a shut in gas well was subject to both the method of the present invention and to the conventional buildup test resulting in a Horner Plot D. The objective was to determine measures of the reservoir permeability and skin factor. In this case, the well was not a flowing well and the original volume in the well was already known, therefore steps A and B were not required. A critical prover was installed on the wellhead. The well had a static pressure of about 5000 kPa.

Having reference to FIG. 9, the well was flowed for about 48 hours in preparation for the buildup test. Just before the buildup test, a one hour sample of the drawdown was recorded at E for implementing the present invention. After a further 2 weeks time, the Horner plot D was developed and using conventional calculations, the permeability k was determined as about 0.58 and the apparent skin s′ of −3.1. These results we obtained only after more than two weeks of buildup.

Returning to FIG. 8, and using the principles for the embodiment of step B, a theoretical curve 53 was determined for a one hour sample taken weeks before the conclusion of the buildup test. A smoothed pressure curve 22 is also illustrated which deviated from the theoretical, clearing indicating there was fluid inflow. Using the principle for the embodiment of step C, the inflow rate was determined as curve 50 at an average of about 80 m³/d. The wellhead flow was shut in at the end of the drawdown, at 40, and the beginning of the buildup. Lastly on FIG. 8, without an outflow, the prior art closed-chamber test was implemented at F to calculate the inflow which diminished as the pressure built up. Note that the initial inflow rates calculated using the closed-chamber test matched those determined using step C, confirming the method for calculating inflow values while flowing from the well. The inflow rates, well volume and pressure response were used to determine the near wellbore characteristics. The method of the invention determined that the permeability k was determined in about the same order of magnitude as determined by the Horner Plot, as about 0.78, and with and apparent skin s′ of −3.9.

### EXAMPLE IV

As determined in the embodiment for step B, a theoretical relationship is established for the inter-relationship between flow rate through a critical prover orifice plate, well gas volume, inflow rate, drawdown pressure and time. The relationship is very useful in assisting well service and testing personnel so as to obtain the best data with the least time and interruption of the well. The relationship as developed shown in equation (6) and reproduced again here for reference.

$$C ( {t}_{2} - {t}_{1} ) = - KV ln ( \frac{{CP}_{2} - KV \frac{ⅆ P}{ⅆ {t}_{closed}}}{{CP}_{1} - KV \frac{ⅆ P}{ⅆ {t}_{closed}}} )$$

As illustrated above, the embodiment of step C relies on sufficient duration to affect the reservoir. One can understand that selection of flow capacity of the critical prover can significantly affect the time of the test. If a prover is too large, then Qout is large and the pressure will fall quickly and the test may be over before the reservoir is affected. Accordingly, one may wish to specify that for a given pressure drop in the well, a known inflow rate and gas volume from the closed-chamber test, and a desired test duration, one only has a single variable left to solve for, that being the prover characteristic C.

Others may not know the gas volume, but a short outflow test through a prover of known characteristic C, for a known time t₂−t₁ and a known change in pressure dP/dt leaves only the volume V which can now be solved for.

The applicability and advantages of the system include:

Investigation of a well is reduced from a conventional duration of days and weeks down to mere minutes or an hour or so;

Quantifying the influx of fluid;

Determining the relative gas and liquid components of fluid influx by combining the novel method with

known liquid level sensing methods, or

repeating the novel method to obtain follow-up gas volumes;

Applying the exponential decay of the pressure response curve to the known closed chamber testing methodology so as to more accurately determine the initial volume of gas in the system;

Applying the method to a drill stem test under a nitrogen cushion to establish deviation of the pressure response curve from theoretical and determining fluid influx despite operational constraints; and

The ability to inspect and compare a theoretical and the actual pressure curve so as to ascertain the reservoir response for fluid inflow. How soon the actual response deviates from theoretical is informative. For reservoirs with a high transmissibility, a delay in the deviation is indicative of localized damage. If it is known that other wells in the same reservoir demonstrate a faster deviation, then the slow deviation wells can be targeted for further investigation.

Some examples of the applicability of the method include:

Pumping oil well: Venting the annulus of a pumping well to evaluate the wellbore gas volume, the annular gas rate and the inflow rate of gas and oil when the pump is deactivated.

Gas well testing: Determining sandface gas inflow rates as a gas well is being produced at surface. The present practice is to report the surface flow rate as though it were equivalent to the downhole sandface inflow rate. This is seldom true. For this reason, reservoir computations utilizing rate data are frequently incorrect. This problem is overcome with the new method which calculates adjusted sandface inflow rates directly.

Nitrogen cushion Drillstem Test: Measurements of downhole inflow rates during flow periods of drillstem tests where a nitrogen cushion is simultaneously being vented at surface. The current practice is to simply vent the nitrogen cushion without any measurements, which results in a wasteful total loss of valuable information.

Workover and completion. If a well that is being worked on has a positive pressure, the wellbore volume, gas rates, and fluid inflow can be determined. The calculations of the present invention can easily be done in the morning after the pressure in the well has had a chance to buildup overnight. If the test reveals lack of inflow then valuable time need not be wasted with unnecessary swabbing; and

Surface casing vent tests: Regulatory regulations require that any surface casing blowdown or flow must be measured. The method of the present invention not only measures the flowrate but calculates the volume of gas contained in the annulus.

The embodiments of the invention in which an exclusive property or privilege is claimed are defined as follows:

1. A method of determining the rate of fluid flow into the wellbore of a well from a fluid-bearing reservoir, the wellbore forming a gas volume between a wellhead and the reservoir, there being a pressure differential between within and without the wellbore, the method comprising:
flowing gas out of the wellhead for a prolonged duration sufficient to affect the reservoir;
measuring the rate of gas outflow from the wellhead;
measuring the pressure of the flowing gas at the wellhead over time; and
determining the total rate of fluid inflow from the reservoir as a function of the wellhead gas outflow rate, a change in flowing gas pressure, and a volume of gas in the wellbore.

2. The method as recited in claim 1 wherein the volume of gas in the wellbore is established comprising:
blocking the wellhead and measuring pressure and change in pressure in the wellbore at the wellhead
flowing fluid from the wellhead for a duration insufficient to suibstantially affect the reservoir; and
determining the gas volume in the wellbore as a function of the change in pressure and gas volume assuming all of the fluid inflow from the reservoir is gas and the gas volume remains constant throughout the blocking and flowing steps.

3. The method as recited in claim 1 wherein the total inflow of fluid into the wellbore Qₜₒₜ is gas and is determined by the following relationship:
$${Q}_{tot} = {Q}_{out} + KV \frac{ⅆ P}{ⅆ {t}_{open}}$$
and Qₜₒₜ=ΔQ+Qᵢₙ
where ΔQ is an incremental fluid inflow rate from the reservoir, Qᵢₙ is the original rate of fluid inflow and V is the gas volume, Qₒᵤₜ is the measured rate of gas flow from the wellhead, K is a constant, and
$$\frac{ⅆ P}{ⅆ {t}_{open}}$$
is the rate of change of pressure in the wellbore measured when the wellhead is open for a prolonged duration.

4. The method as recited in claim 1, wherein the fluid inflow from the reservoir is only liquid and is determined as the absolute value of an incremental change in gas volume for the wellbore over an increment of time, said incremental change in gas volume being a function of the measured flow of gas through the port, the change in pressure over time while the port is open, the original rate of gas flow, the gas volume, and an average of the pressure over the increment of time.

5. The method as recited in claim 4 wherein the total inflow of fluid into the wellbore Qₜₒₜ is only liquid, then rate of gas flow Qᵢₙ is zero, and the inflow rate of liquid is determined as the absolute value of the incremental rate of change in gas volume dV for the wellbore over an increment of time dt using the relationship:
$$\frac{ⅆ V}{ⅆ t} = ( \frac{{Q}_{out}}{K \overline{P}} - \frac{( V + \sum ⅆ V )}{P} \frac{ⅆ P}{ⅆ t} )$$
where V is the gas volume, Qₒᵤₜ is the measured rate of gas flow from the wellhead, K is a constant,
$$\frac{ⅆ P}{ⅆ t}$$
is a rate of change of pressure in the wellbore measured when the wellhead is open and fluid continues to flow, \overline{P} is the average pressure for the increment in time dt, and P is the instantaneous pressure at the wellhead.

6. The method as recited in claim 1, wherein the fluid inflow from the reservoir is both gas and liquid, further comprising:
blocking the wellhead after the prolonged flow;
determining a final gas volume in the wellbore after the prolonged flow;
determining the rate of liquid inflow as the difference between the gas volume and the final gas volume as a function of time over the prolonged duration;
determining the rate of gas inflow as the difference of the total fluid inflow rate and the liquid inflow rate.

7. The method as recited in claim 6, wherein the final gas volume in the wellbore after the prolonged duration is determined by:
blocking the wellhead and measuring pressure and change in pressure in the wellbore at the wellhead
flowing fluid from the wellhead for a duration insufficient to substantially affect the reservoir; and
determining a new gas volume in the wellbore, which represents the final gas volume, as a function of the change in pressure and gas volume assuming all of the fluid inflow from the reservoir is gas and the gas volume remains constant throughout the blocking and flowing steps.

8. A method for determining gas volume in a wellbore, the wellbore fitted with a wellhead comprising:
establishing a first linear relationship of the rate of gas flow as a function of the unknown gas volume and a measured change in pressure of the wellbore adjacent the wellhead when the wellhead is closed;
establishing a second exponential relationship of the rate of gas flow as a function of the unknown gas volume, the measured flow of gas at the wellhead, and the measured change in pressure in the wellbore adjacent the wellhead when the wellhead is open; and
simultaneously solving the first and second relationships for gas volume.

9. The method as recited in claim 8 wherein
the first relationship is
$${Q}_{in} = KV \frac{ⅆ P}{ⅆ {t}_{closed}} ;$$
and
the second relationship is
$${Q}_{in} - {Q}_{out} = {KV}_{o} \frac{ⅆ P}{ⅆ {t}_{open}}$$
where Qₒᵤₜ=PC, and
where K and C are constants,
$$\frac{ⅆ P}{ⅆ {t}_{closed}} and \frac{ⅆ P}{ⅆ {t}_{open}}$$
are rates of change of pressure measured at the wellhead when the wellhead is closed and open respectively, Qᵢₙ is an original rate of gas flow when the wellhead is closed, Qₒᵤₜ is the measured rate of gas flow through the wellhead when open, and V is the gas volume.

10. The method as recited in claim 9 further comprising:
integrating the second relationship with respect to time between t₁ and t₂;
substituting the first relationship for Qᵢₙ into the integrated second relationship to yield a third relationship
$$C ( {t}_{2} - {t}_{1} ) = - KV ln ( \frac{{CP}_{2} - KV \frac{ⅆ P}{ⅆ {t}_{closed}}}{{CP}_{1} - KV \frac{ⅆ P}{ⅆ {t}_{closed}}} ) ;$$
selecting a first pair of pressure values measured as a function of time for the step where the wellhead is closed for determining
$$\frac{ⅆ P}{ⅆ {t}_{closed}} ;$$
selecting a second pair of pressure values measured as a function of time for the step where the wellhead is open, said second pair of values being pressure P₁ at time t₁ and pressure P₂ at time t₂;
solving the third relationship for the gas volume V knowing
$$\frac{ⅆ P}{ⅆ {t}_{closed}} ,$$
P₁,t₁ and P₂,t₂; and
solving for the original rate of gas flow Qᵢₙ.

11. The method as recited in claim 10 wherein a theoretical reservoir pressure response curve is created comprising:
rearranging the third relationship to form a fourth relationship
$${P}_{2} = ( {CP}_{1} - {Q}_{in} ) {ⅇ}^{\frac{- C ( {t}_{2} - {t}_{1} )}{KV} } + \frac{{Q}_{in}}{C} ;$$
and
iteratively creating a curve of P₂ over time representing the theoretical reservoir pressure response as if there is no incremental inflow of fluid from the reservoir.

12. The method as recited in claim 10 wherein a qualitative analysis of the inflow rate from the reservoir is obtained by:
creating an actual pressure response curve resulting from the measured pressure and rate of change of pressure in the wellbore over time while flowing gas from the open wellhead for the prolonged duration; and
comparing the theoretical and actual pressure response curves, any deviation between the theoretical and the actual pressure response curves representing fluid inflow from the reservoir.

13. The method as recited in claim 11 further comprising:
plotting the theoretical pressure response curve and the actual pressure response curves on a computer display.

14. The method as recited in claim 11 further comprising:
creating a curve representing the total fluid flow from the reservoir; and
displaying the total fluid flow curve with the theoretical and actual pressure response curves on a computer display.
